(19) United States
(12) Patent Application Publication
(10) Pub. No.: US 2026/0022077 A1
(43) Pub. Date: Jan. 22, 2026

(54) HIGH STRENGTH POLYMER-DERIVED CERAMIC FOAMS - COMPOSITION AND METHODS

(71) Applicant: Dynamic Material Systems LLC, Oviedo, FL (US)

(72) Inventors: Walter Sherwood, Ballston Lake, NY (US); Ryan Trammell, Oviedo, FL (US); Kirk Miller, Clermont, FL (US); William Easter, Chuluota, FL (US)

(21) Appl. No.: 19/274,041

(22) Filed: Jul. 18, 2025

Related U.S. Application Data
(60) Provisional application No. 63/672,972, filed on Jul. 18, 2024.

(51) Int. Cl. C04B 38/06; C04B 38/00; C04B 38/02; C04B 38/10

(52) U.S. Cl. CPC C04B 38/067; C04B 38/0054; C04B 38/02; C04B 38/069; C04B 38/10; C04B 2235/483; C04B 2235/528

(57) ABSTRACT

Foam compositions comprising an inorganic resin matrix or a polymer-derived ceramic matrix are provided, as well as methods of fabricating the same. The foams may or may not contain additional functional fillers to control mechanical and/or thermophysical properties. The foam materials can include a novel combination of tailorable inorganic siloxane resins with unique fillers, and unique methods of producing the desired porosity. Unlike related art foams, the foams of embodiments of the subject invention can be inorganic-resin-based, and can be closed cell foams or semi-closed cell foams.

### CROSS-REFERENCE TO RELATED APPLICATION

This application claims the benefit of U.S. Provisional Application Ser. No. 63/672,972, filed Jul. 18, 2024, the disclosure of which is hereby incorporated by reference in its entirety, including all figures, tables, and drawings.

### BACKGROUND

Organic resin-based foams (e.g., polyethylene, polystyrene, and polyurethane) can be either open cell (e.g., typical polyurethane) or closed cell (e.g., polyethylene). Most ceramic foams are open cell, made either by templating on polyurethane foams, which involves coating the polyurethane with a ceramic slurry, drying the slurry, and burning the polyurethane out during the early part of the ceramic sintering process. The ceramic sintering process requires high temperatures (e.g., greater than 1,400° C.) and results in significant shrinkage, which can increase the effective density of the foams and cause cracking. Carbon-based foams can be made in a similar method to ceramic foams, or they can use the volatiles in the carbon source as the blowing agent. Carbon and graphite open cell foams can be made by using the volatiles in the petroleum or coal tar pitch to produce the porosity. The pore formation and size can also be varied by using pressure and/or vacuum.

### BRIEF SUMMARY

Embodiments of the subject invention provide novel and advantageous foam compositions comprising an inorganic resin matrix or a polymer-derived ceramic matrix, as well as methods of fabricating the same. The foams may or may not contain additional functional fillers to control mechanical and/or thermophysical properties. The foam materials can include a combination of inorganic siloxane resins with fillers, and novel methods of producing the desired porosity.

### DETAILED DESCRIPTION

Embodiments of the subject invention provide novel and advantageous foam compositions comprising an inorganic resin matrix or a polymer-derived ceramic matrix, as well as methods of fabricating the same. The foams may or may not contain additional functional fillers to control mechanical and/or thermophysical properties. The foam materials can include a novel combination of tailorable inorganic siloxane resins with unique fillers, and unique methods of producing the desired porosity. Unlike related art foams, the foams of embodiments of the subject invention can be inorganic-resin-based, and can be closed cell foams or semi-closed cell foams.

The foam materials of embodiments of the subject invention can utilize the unique features of inorganic (primarily siloxane-based or polycarbosilane-based) polymers. Such polymers have the ability to bond with most types of fillers (e.g., nominally inorganic powders such as silica, alumina, calcium carbonate, talc, mica, fly ash, etc.), as well as carbon-based materials including coal, petroleum coke, coal-based coke, graphite, graphene, and carbon nanotubes. The siloxane polymers are non-toxic, non-flammable, typically hydrophobic, and do not have objectionable odors at room temperature. The siloxane polymers have a very high char yield when pyrolyzed (e.g., at least 70% by mass), and can convert to ceramic at temperatures as low as 900° C., well below typical sintering temperatures of 1,400+° C. This allows the use of low-cost furnaces and lower energy expenditures for processing.

The foam materials of embodiments of the subject invention can include unique filler/blowing agent combinations, such as the use of bituminous coal, lignite coals, petroleum coke, coal-based coke, and/or pyrolyzed coal tar pitch as structural and property modifying fillers. The natural volatile components in the coals can be used as a blowing agent by modifying the cure behavior of the resin to match the evolution temperature of the volatile species. Also, adsorbed water on powdered coal, coke, or graphite can be used as a blowing agent to form the porosity. Powdered coal typically has between 1.5% and 8% adsorbed water due to contact with the nominal humidity in ambient air. Controlled amounts of adsorbed water can be deliberately added to coal, coke, carbon-based fillers, or other types of fillers (e.g., oxides and/or carbonates). This water can then volatilize to produce porosity. In addition, powders can be used resulting from the mineralization of produced water or other sources of divalent metals by the reaction of carbon dioxide with the produced water or divalent metals sources. The resulting mixed carbonate powders can be used as fillers with in situ blowing agents to produce foamed materials because the carbonates retain significant adsorbed water.

Embodiments of the subject invention can include using an inorganic polymer/water emulsion, which can then be mixed with water adsorbing fillers (e.g., coal, coke, mixed carbonate, and/or other fillers). The majority of the water can evaporate below the cure temperature, while some of the water can absorb onto the filler and evolve during the curing process to produce the required porosity for the foam. This method allows higher, more controlled filler contents while still providing significant porosity. This method can produce foams that are stronger at a lower density compared to the related art.

Embodiments of the subject invention can include using coal and/or mixed carbonate fillers in combination with hollow glass microspheres, phenolic microspheres, polymethyl methacrylate (PMMA), and/or other plastic microspheres to produce dual mode or combination foams where the filler with the in situ blowing agent is mixed with the microspheres, molded, and cured to produce a strong foam with very low density.

Embodiments of the subject invention can include designing an inorganic siloxane polymer to have one or more reactive groups to produce the foaming agent during curing. The reactive groups can include hydride groups (Si—H) and/or silanol groups (Si—OH). These groups can produce a blowing agent by multiple reactions. In one reaction, the two groups can be reacted with each other using a metal complex catalyst to produce hydrogen and a Si—O—Si crosslink bond. The catalysts can be one or more complexes of, for example, platinum, tin, zinc, boron, and/or 1,4-diazabicyclo[2.2.2]octane (DABCO), which control the reaction rate and affect the cure temperature. In another reaction, the Si—H groups can react with absorbed water on the filler and/or added water to produce hydrogen gas and a Si—O—Si crosslink bond. One or more complexes of, for example, platinum, tin, zinc, boron, and/or DABCO can be used to control the reaction rate and modify the cure temperature of the polymer. In another reaction, the OH groups can react with water absorbed on the filler and/or added water to produce water (and/or water vapor, depending on the temperature) and a Si—O—Si crosslink bond. This reaction can be catalyzed by one or more complexes of, for example, platinum, tin, zinc, boron, and/or

DABCO, which can be used to control the reaction rate and modify the cure temperature of the polymer. The processes to produce porosity can also be used to produce foams from siloxane polymers with one or more of Si—H and/or SiOH functional groups without filler by adding small amounts of water dropwise while stirring the resin. These foams are lower in density and strength, but when converted to ceramic, are stable in air to temperatures of at least 1,200° C.

Depending on the filler, foams made with other fillers may only be stable to a temperature in a range of from 250° C. to 350° C. in air if the foam is not converted to ceramic. Foams made with relatively low amounts of carbon-based filler (e.g., 50% or less by mass) are more stable in air after conversion to ceramic than carbon/graphite-based foams in the related art. The carbon-filled siloxane ceramic foams are stable at higher temperatures than carbon- and graphite-based foams in the related art (e.g., 400° C. to 500° C. versus 350° C. for current carbon/graphite foams).

Embodiments of the subject invention can produce oxidatively stable, low density, closed cell and/or semi-open cell ceramic foams with oxidation stability up to a temperature of at least 1,400° C. These foams can be fabricated by first using fine coal powder, coke powder, and/or graphite powder as a filler to make siloxane foams by any of the methods disclosed herein. The foams can be pyrolyzed to convert them to ceramic, producing high strength ceramic foams. These foams can then be heated in flowing air and/or oxygen (e.g., at a temperature of at least 400° C., for a minimum of 1 hour per quarter inch of foam thickness) to oxidize away the coal, coke, and/or graphite powder. The resulting foam can be lower in density due to the loss of the mass of the carbon-based filler. By varying the amount of coal/carbon powder filler, the amount of mass loss, density decrease, and strength loss can be controlled.

Resins that can be used with embodiments of the subject invention include inorganic resins including but not limited to linear, branched, or hyperbranched siloxane polymers containing the following functional groups on the backbone/main chain/or attached as substituents on one or more silicon atoms in siloxane monomer or polymer. The pendant groups on the polymer chain can include but are not limited to methyl, dimethyl, vinyl, divinyl, hydride, phenyl, diphenyl, silanol, hydroxy, dihydroxy, trihydroxy, and/or methacrylate.

Inorganic resins or polymers produced by the platinum catalyzed reaction between methylhydrogen siloxane and dicyclopentdiene or other unsaturated liner or cyclic carbon can include monomers such as divinylbenzene or butadiene.

Polymers produced by acid or base catalysis of methoxysilanes or ethoxysilanes can include one or more of the following attached to one or more silicon atoms in the monomer-methyl, dimethyl, vinyl, divinyl, hydride, phenyl, diphenyl, silanol, hydroxy, and/or methacrylate.

Example polymers that can be used with embodiments of the subject invention include: Semplastics' XM series polymers including but not limited to XM-804 series, XM-704, XM-708, XM-734, XM-604, XM-774, XM-504, B183, B212, B251, and B231; commercial siloxane polymers including but are not limited to Starfire Systems' RD 684, RD 688, and RD 212, and Wacker Chemie's SILRES H62C and TS-40 ethylsilicate, and its variants.

Other inorganic polymers that can be used to produce foams using the foaming agents and techniques of embodiments of the subject invention include: Starfire Systems' SMP-10 silicon carbide precursor which would produce silicon carbide foams instead of the silicon oxycarbide ceramic examples discussed herein; silazanes; carbosilanes; carbosilazanes; and other inorganic ceramic-forming precursor polymers.

Once the polymer has been synthesized, a crosslinker can be added. The crosslinkers can be vinyl containing silane, siloxane, or organic monomers including but not limited to: tetramethyltetravinylcyclotetrasiloxane (which can be referred to herein as “TVC”); divinyl benzene; styrene monomer; tetraethylorthosilicate (which can be referred to herein as “TEOS”); DABCO; and tetramethylcyclotetrasiloxane, which is a cyclic compound with four silicon hydride groups. The crosslinkers can increase the ceramic yield of the base polymers and improve curing behavior, as well as improve hardness and tear strength of the cured polymer.

Catalysts can be used to control the cure temperature of the polymers to improve control over the foaming reaction. The cure temperature of the resin can be tailored to the activation temperature of the blowing agent. The catalysts that can be used with embodiments of the subject invention include platinum catalysts, peroxide catalysts, DABCO, tin/zinc/boron-based organometallic condensation catalysts, aluminum and/or transition metal alkoxides, and metal-complex catalysts. Platinum catalysts can include but are not limited to Ashby's catalyst and Karstedt's catalyst, or other materials containing one or more platinum complexes that react with silicon hydride (Si—H) groups and/or silanol groups (Si—OH), and will also crosslink Si—H groups with Si-vinyl groups if any are designed into the polymer. Peroxide catalysts can include but are not limited to Luperox 531, Luperox 231, Luperox DI, Dicumyl peroxide, and/or any peroxide with at least a 10-hour half-life temperature above 85° C. Tin/zinc/boron-based organometallic condensation catalysts can include but are not limited to dibutyltin dilaurate and zinc octoate. Aluminum and/or transition metal alkoxides can include but are not limited to aluminum butoxide, aluminum propoxide, zirconium butoxide, titanium butoxide, and/or hafnium butoxide. Metal-complex catalysts can include but are not limited to dibutyltindilaurate, zinc octoate, or other metal-complex catalysts that react with silanol or hydroxy groups on silicon atoms. In some embodiments, no catalyst is used, and the resins will still cure without a catalyst, but at a higher temperature. In some cases, volatiles within the polymer can be used as in situ blowing agents. The cure yield and ceramic yield of an uncatalyzed polymer is typically lower than a catalyzed version of a polymer with the same or similar composition.

The foaming agents or blowing agents generate controlled porosity within the polymer as it cures. It is important to tailor the curing temperature of the polymer to the activation temperature of the foaming or blowing agent. The blowing agents that have been shown to function with inorganic siloxane polymers include but are not limited to water, alcohol, hydrogen gas, citric acid, sodium carbonate, sodium bicarbonate, carbon dioxide, nitrogen, in situ blowing agents generated by the reaction of substituent groups on the siloxane polymer chain (e.g., Si—H and/or Si—OH groups), unreacted monomers in the siloxane polymer, DABCO, and/or commercial blowing agents for polyurethane and polyolefins. Also, furfural alcohol and petroleum pitch, as well as coal tar pitch, can function as foaming agents in siloxane-based polymers.

Fillers add bulk to a siloxane-based foam material. Depending on the size, shape, and morphology the filler can improve structural strength, and can increase or decrease density, thermal conductivity, heat capacity, thermal expansion, and/or thermal diffusivity. In embodiments of the subject invention, fillers can serve a dual purpose, providing a source of the foaming or blowing agent as well as modifying the mechanical and/or thermophysical properties of the resultant foams. The fillers that can be used with embodiments of the subject invention include carbon-based fillers, non-carbon-based fillers, and density decreasing fillers; these can be utilized to produce both ceramic and plastic matrix foams.

Carbon-based fillers include lignitic coal, bituminous coal, coal fines, coal waste, petroleum coke and petroleum coke fines, metallurgical coke, anthracite coal, coke derived from coal, and graphite derived from coal. Milled carbon fibers, chopped carbon fibers, and graphene can also be used, as can forms of coal waste such as fly ash, bottom ash, and/or shale coal. Forms of non-coal carbon can be used including but not limited to as bio-char, rice hulls, charcoal, and/or agricultural waste. Coal-based aggregates can be used (i.e., the ceramic product made by pyrolyzing a mixture of siloxane polymer and any type of raw coal powder, coal coke powder, and/or coal tar pitch at a temperature of 700° C. to 1200° C.). Non-Coal carbon-based aggregates can be used (i.e., the ceramic product made by pyrolyzing a mixture of siloxane polymer and any type of material containing greater than 40% carbon including but not limited to petroleum coke powder, petroleum pitch, bio-char, rice hulls, agricultural waste, and/or hemp, at a temperature of 700° C. to 1200° C.).

Non-carbon-based fillers can range from oxide ceramic powders or oxides formed in situ during processing, including but not limited to alumina, silica, titania, magnesia, and zirconia. Other fillers that can be used include siloxane foams using calcium carbonate and mixtures of carbonates formed by the mineralization of produced water or other alkaline sources of divalent metals by carbon dioxide, including from captured carbon dioxide or point source carbon dioxide.

Density decreasing fillers can be used to make syntactic foams. Solid fillers with unique characteristics can also be used to produce “syntactic foams” where there is no blowing agent, and the filler creates the porosity and decreases the density of the component by displacing resin or resin+filler. The fillers are typically either hollow spheres or low-density solid spheres. Examples of fillers to produce syntactic foams in this invention include but are not limited to hollow glass microspheres, hollow plastic microspheres (e.g., phenolic microspheres), solid low density plastic spheres (e.g., polyethylene, polypropylene, polystyrene, or PMMA), hollow ceramic spheres (e.g., spherical fly ash), and/or cenospheres. Typically, the spheres can be less than 100 micrometers in diameter and either hollow or made from a lightweight plastic. In making the ceramic foams of embodiments of the subject invention, foams can be produced using hollow phenolic microspheres, hollow glass microspheres, solid PMMA microspheres, and combinations of those materials. Hollow plastic microspheres (referred to as “expancel” microspheres, from a company called “Nouryon”) can be used to produce ceramic foams. Combination foams using both a blowing agent and hollow glass spheres can also be fabricated.

A bi-layer material can also be produced by first forming one layer with little or no foaming agents or microspheres in a mold. Subsequently, a more highly foamed layer can be laid onto the less foamed layer. The two can be cured and pyrolyzed together to make a dual layer material with a harder, denser surface and less dense insulating foam layer bonded to it. This dual layer technique has been shown to work for any filler type and with just resin and no filler.

Embodiments of the subject invention include foam materials that do not utilize any fillers but rely on the cured or pyrolyzed siloxane ceramic to provide the structural and thermal properties of the material. In general, non-filled foamed resin systems are insulators with a low thermal expansion coefficient, low heat capacity, and low density. These foams are typically generated by the reaction of silicon hydride and/or silanol or alkoxy groups that are present as pendant groups on the inorganic polymer.

Embodiments of the subject invention provide at least the following (any of the ceramic foam materials mentioned can be formed using at least one inorganic polymer, such as a siloxane-based polymer).
Ceramic foam materials resulting from siloxane-based polymers mixed with fillers and optionally foaming agents and/or blowing agents as described herein.
A ceramic foam produced from compositions containing 0% to 80% by mass bituminous coal, including low volatile bituminous coal and/or high volatile bituminous coal.
A ceramic foam produced from compositions containing 0% to 80% by mass lignite coal.
A ceramic foam produced from compositions containing 0% to 80% by mass sub-bituminous coal.
A ceramic foam produced from compositions containing 0% to 80% by mass anthracite coal.
Ceramic foam compositions containing combinations of two or more coal types with sum of the masses of all coal being in a range of from 1% to 80% by mass.
A ceramic foam produced from compositions containing 0% to 70% carbon powders from non-coal sources (e.g., biochar, agricultural waste, and/or charcoal).
A ceramic foam formed from compositions containing 0% to 85% by mass coal or carbon-based ceramic aggregate.
Ceramic syntactic foams containing porosity formed from the inclusion of 0.1% to 30% by mass hollow glass microspheres, or other commercially available microspheres in the material.
Syntactic foams containing porosity formed from the inclusion of 0.1% to 20% by mass hollow glass microspheres and 0% to 60% by mass any form of coal powder in the material.
Ceramic foam materials containing porosity generated by the use of DABCO as a catalyst, a blowing agent, or both.
Ceramic foam materials containing porosity generated by the use of DABCO as a blowing agent and a platinum complex as a catalyst.
Ceramic foam materials containing porosity generated by the use of DABCO as a catalyst, a blowing agent, or both, and using hollow glass microbeads to further decrease the density of the ceramic foam.
Ceramic foam materials containing porosity generated by water adsorbed onto the filler powders vaporizing and producing pores.
Ceramic foam materials containing at least one filler (e.g., coal powders, non-coal carbon powders, oxides, and/or carbonates) and porosity generated by water that had adsorbed onto the filler(s).
Ceramic foam materials containing porosity generated by the reaction between silicon hydride and silanol pendant groups on a siloxane polymer chain.
Ceramic foam materials containing porosity generated by the reaction between silicon hydride and silanol pendant groups and the siloxane polymer chain. The reaction can be catalyzed by either a platinum complex catalyst or a tin complex catalyst to decrease the cure temperature and help cure the foam.
Ceramic foam materials containing at least one filler (e.g., coal powders, non-coal carbon powders, oxides, and/or carbonates) and porosity generated by the reaction between silicon hydride and silanol pendant groups on a siloxane polymer chain.
Ceramic foam materials containing at least one filler (e.g., coal powders, non-coal carbon powders, oxides, and/or carbonates) and porosity generated by the reaction between silicon hydride and silanol pendant groups on a siloxane polymer chain. A platinum complex or tin complex catalyst can also be used to decrease the cure temperature of the material and help form the foam.
Ceramic foam materials containing porosity generated by the reaction of water (with or without surfactants) with silicon hydride and/or silanol pendant groups on a siloxane polymer chain.
Ceramic foam materials containing powder fillers and containing porosity generated by the reaction of water (either adsorbed onto the filler powders or added during mixing) with silicon hydride and/or silanol pendant groups on a siloxane polymer chain.
Ceramic foam materials generated by water remaining from an emulsion of siloxane polymer in water utilizing a surfactant to form the emulsion and prevent or inhibit re-agglomeration of the resin micels.
Ceramic foam materials with porosity generated by the reaction of silicon hydride and/or silanol pendant groups with an added alcohol-containing reactant (e.g., a metallic (e.g., zirconium) proproxide or butoxide).
Ceramic foam materials with porosity generated by the reaction of silicon hydride and/or silanol pendant groups with an added alcohol containing reactant (e.g., a metallic (e.g., zirconium) proproxide or butoxide) and a catalyst to decrease the cure/reaction temperature to near room temperature.
Ceramic foam materials comprising sequential layers of foams generated by different methods as disclosed herein. For example, a bilayer foam can comprise a first layer of foam fabricated by the action of a foaming agent on the filled or unfilled siloxane resin, and a second layer fabricated by using hollow glass microspheres (with or without a filler in the siloxane resin). The two layers can be bonded together during curing and/or pyrolysis. As another example, a trilayer material can include a filled but non-foamed layer bonded to the bilayer foam already discussed, and all three layers can be bonded together during curing and/or pyrolysis.

When ranges are used herein, combinations and subcombinations of ranges (including any value or subrange contained therein) are intended to be explicitly included. When the term “about” or “approximately” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1—Emulsion Method 1 (RT240126-RT240227)

In a first method of fabricating a foam composition, the following six steps can be performed.

1. Thoroughly mix resin, crosslinker, and surfactant using an impeller blade or high-shear dispersion blade.

2. Add catalyst to the resin mixture and disperse quickly. All steps following should be done in a timely manner to avoid resin gelation prior to completion of the procedure.

3. If not already done so, the high-shear dispersion blade should be installed into the mixer and utilized for the remaining mixing steps. Disperse water into the catalyzed resin mix in a dropwise or semi-dropwise manner. The mixer should be set to a high speed to ensure fine dispersion of the water droplets into the resin to form and homogenous and stable emulsion.

4. After a sufficiently homogenous and stable emulsion has been formed, the powdered foaming agents (e.g., baking powder and/or baking soda) and/or filler particles can be added and dispersed into the emulsion.

5. After sufficient mixing, the emulsion slurry can be poured into a mold.

6. The samples are then placed into an oven and cured (e.g., at 90° C. or about 90° C.).

### Example 2—Emulsion Method 2 (RT240409)

In a second method of fabricating a foam composition, the following five steps can be performed.

1. Thoroughly mix resin, crosslinker, and surfactant using an impeller blade or high-shear dispersion blade.

2. Add catalyst to the resin mixture and disperse quickly. All steps following should be done in a timely manner to avoid resin gelation prior to completion of the procedure.

3. Disperse water into the catalyzed resin mix in a dropwise or semi-dropwise manner using a high-shear dispersion blade. The mixer should be set to a high speed to ensure fine dispersion of the water droplets into the resin to form and homogenous and stable emulsion.

4. Add glass microspheres to the mixture until a paste-like material is formed. As the particle loading increases, mixing will have to be done by hand with a rubber or metal spatula.

5. Load the paste material into a mold and cure in an oven.

### Example 3—Emulsion Method 3 (RT240710-RT240711)

In a third method of fabricating a foam composition, the following seven steps can be performed.

1. Thoroughly mix resin, crosslinker, catalyst, and any solid filler particles using an impeller blade or high-shear dispersion blade.

2. Disperse surfactant and 1,4-diazabicyclo[2.2.2]octane (DABCO) into water using a stirring hotplate (e.g., set to between 50° C. and 70° C.).

3. Disperse the water solution dropwise into the resin mixture using the high-shear dispersion blade set to a high speed. This should form a uniform and stable emulsion. The mixture will begin to foam but continue mixing until the mixture becomes thickened but is still fluid enough to be remixed into itself.

4. Transfer the material into molds.

5. Allow to rise/cure for several hours at room temperature.

6. Transfer the samples to an oven for further curing (e.g., at a temperature in a range of from 50° C. to 100° C.).

7. Pyrolyze in an inert gas oven under nitrogen (e.g., at 800° C. to 1100° C.) and hold at temperature (e.g., for 2-4 hours).

### Example 4

A foam was fabricated with the following ingredients: DABCO; XM-604 siloxane resin; 5 micron bituminous coal powder; and 30 micron glass microspheres (FibreGlast Part #22). First, 100 grams (g) of XM-604 siloxane polymer was mixed with 5 g of DABCO until the DABCO dissolved. Separately, in a mixer (e.g., a Kitchen Aid mixer), 50 g of 5 micron bituminous coal powder was mixed with 10 g of glass microspheres. The resin mixture was added to the dry ingredients and mixed for 15 minutes (min) (until a uniformed slurry mixture was formed). Once mixed, the mixture was poured into a silicone mold filling ⅓ (or about ⅓) of the cavity. Then, it was left to stand for 30 minutes to 1 hour to allow big air bubbles to rise to the surface. Using techniques like tapping the mold on the table or light vibrations for a couple of minutes can help this process. Next, specimens were cured in the oven (program 4) in Grieve to 190° C. for 4 hours (h). After curing, specimens were fired in a furnace in nitrogen to 1000° C. and held at this temperature for a minimum of 2 h.

These specimens had a bulk density (after curing) of 0.19 grams per cubic centimeter (g/cc), a bulk density (after firing in the furnace) of 0.27 g/cc, and a flexural strength of 282.74 pounds per square inch (psi).

### Example 5

A foam was fabricated with the following ingredients: DABCO; XM-604 siloxane resin; and 5 micron bituminous coal powder. First, 100 g of XM-604 siloxane polymer was mixed with 5 g of DABCO until the DABCO dissolved. Separately, in a mixer (e.g., a Kitchen Aid mixer), 50 g of 5 micron bituminous coal powder was disposed. The resin mixture was added to the dry coal powder and mixed for 15 min (until a uniformed slurry mixture was formed). Once mixed, the mixture was poured into a silicone mold filling ⅓ (or about ⅓) of the cavity. Then, it was left to stand for 30 minutes to 1 hour to allow big air bubbles to rise to the surface. Using techniques like tapping the mold on the table or light vibrations for a couple of minutes can help this process. Next, specimens were cured in the oven (program 4) in Grieve to 190° C. for 4 h. After curing, specimens were fired in a furnace in nitrogen to 1000° C. and held at this temperature for a minimum of 2 h.

These specimens had a bulk density (after curing) of 0.24 g/cc, a bulk density (after firing in the furnace) of 0.36 g/cc, and a flexural strength of 597.39 psi.

### Example 6

A foam was fabricated with the following ingredients: DABCO; XM-604F siloxane resin; acetone; lignite coal powder; 30 micron glass microspheres (FibreGlast Part #22); and a platinum complex catalyst (which can be referred to herein as “Cat Tx”). First, 100 g of XM-604F siloxane polymer was mixed with 5 g of DABCO, 10 g of acetone, and 2 g of Cat Tx until the DABCO dissolved. Separately, in a mixer (e.g., a Kitchen Aid mixer), 100 g of lignite coal powder (particle size of 70 microns or less) was mixed with 7 g of hollow glass microspheres. The resin mixture was added to the dry coal powder and mixed for 15 min (until a uniformed slurry mixture was formed). Once mixed, the mixture was poured into a silicone mold filling ⅓ (or about ⅓) of the cavity. Then, it was left to stand for 30 minutes to 1 hour to allow big air bubbles to rise to the surface. Using techniques like tapping the mold on the table or light vibrations for a couple of minutes can help this process. Next, specimens were cured in the oven (program 4) in Grieve to 190° C. for 4 h. After curing, specimens were fired in a furnace in nitrogen to 1000° C. and held at this temperature for a minimum of 2 h.

These specimens had a bulk density (after curing) of 0.498 g/cc and a bulk density (after firing in the furnace) of 0.631 g/cc.

### Example 7

Adsorbed water present on the exterior surface and/or in the pores of a coal filler powder was used as a blowing agent (typical coal powder has between 1.5% and 6% adsorbed water depending on the ambient humidity). The amount of water and hence the amount of porosity can be varied by controlling the moisture content of the coal or other fillers, such as carbonate powder or biochar.

The materials included bituminous coal (particle size of 30 micrometers or less), XM-804 resin, and Cat Tx.

First, 410 g of under 30-micron bituminous coal powder was weighed out and dried in a convection oven at 120° C. for 4 h to 6 h, or until the mass didn't change with further heating. The powder was weighed to determine its dry mass. The powder was placed in a convection oven set at 60° C. to 80° C. with a tray of water also in the oven. The mass was monitored every 30 minutes until the mass gain was 4% to 5%.

Then, 200 g of XM-804 resin was mixed with 0.5 parts per hundred (Phr) of Cat Tx and stirred for 15 min to thoroughly mix. Next, 400 g of the moisture containing bituminous coal powder was added to a mixer (e.g., Kitchen Aid or other planetary mixer). With the mixer running (e.g., at a setting of “2”) the 200 g of catalyzed resin was added over a 30 second interval. Mixing continued (e.g., at a setting or 2 or 3) for 5 min to 10 min, after which the mixture should be a very flowable material. With a spatula, the mixture was poured into a mold and the mold/mixture was heated at 2° C. per minute to 70° C. and held for 2 h to form the foam. Once the foam was formed, the material was further cured and hardened by heating at 2° C. per minute to 160° C. to 190° C. and held for 2 h. The part was de-molded, placed on a ceramic plate, and inserted into an inert gas furnace, where it was then heated at 1° C. per minute to 1000° C. under nitrogen and held for 2 h to 4 h. It was then left to cool in the furnace. After cooling, the part had a density in a range of from 0.7 g/cc to 1.1 g/cc.

### Example 8

Volatiles contained in the coal filler were used as the blowing agent. The materials included lignite coal (particle size of 70 micrometers or less), XM-604 resin, and Cat Tx.

First, 200 g of XM-604 resin was mixed with 1 Phr of Cat Tx and stirred for 15 min to thoroughly mix. Next, 400 g of lignite coal powder (particle size of 70 micrometers or less) was added to a mixer (e.g., Kitchen Aid or other planetary mixer). With the mixer running (e.g., at a setting of “2”) the 200 g of catalyzed resin was added over a 30 second interval. Mixing continued (e.g., at a setting or 2 or 3) for 5 min to 10 min, after which the mixture should be a very flowable material. With a spatula, the mixture was poured into a mold and the mold/mixture was heated at 2° C. per minute to 190° C. and held for 2 h to form the foam and cure the resin.

The part was de-molded, placed on a ceramic plate, and inserted into an inert gas furnace, where it was then heated at 1° C. per minute to 1000° C. under nitrogen and held for 2 h to 4 h. It was then left to cool in the furnace. After cooling, the part had a density in a range of from 0.9 g/cc to 1.3 g/cc.

### Example 9

Ceramic aggregate and hollow glass microspheres were used. The materials included lignite coal (particle size of 70 micrometers or less), XM-604 resin, and Cat Tx.

First, 200 g of XM-604 resin was mixed with 1 Phr of Cat Tx and stirred for 15 min to thoroughly mix. Next, 400 g of lignite coal powder (particle size of 70 micrometers or less) was added to a mixer (e.g., Kitchen Aid or other planetary mixer). With the mixer running (e.g., at a setting of “2”) the 200 g of catalyzed resin was added over a 30 second interval. Mixing continued (e.g., at a setting or 2 or 3) for 5 min to 10 min, after which the mixture should be a very flowable material. With a spatula, the mixture was poured into a mold and the mold/mixture was heated at 2° C. per minute to 190° C. and held for 2 h to form the foam and cure the resin.

The part was de-molded, placed on a ceramic plate, and inserted into an inert gas furnace, where it was then heated at 1° C. per minute to 1000° C. under nitrogen and held for 2 h to 4 h. It was then left to cool in the furnace. After cooling, the part had a density in a range of from 0.9 g/cc to 1.3 g/cc.

### Example 10

Hydride and silanol pendant group reactions were used to produce the blowing agent. The materials included bituminous coal (particle size of 30 micrometers or less), Cat Tx, dibutyltin dilaurate catalyst, and methyl-phenyl vinyl siloxane resin containing silicon hydride pendant groups and silanol pendant groups.

First, 200 g of the resin was mixed with 1 Phr of Cat Tx and 0.8 Phr of dibutyltin dilaurate and stirred for 15 min to thoroughly mix. Next, 400 g of bituminous coal (particle size of 30 micrometers or less) was added to a mixer (e.g., Kitchen Aid or other planetary mixer). With the mixer running (e.g., at a setting of “2”) the 200 g of catalyzed resin was added over a 30 second interval. Mixing continued (e.g., at a setting or 2 or 3) for 5 min to 10 min, after which the mixture should be a very flowable material. With a spatula, the mixture was poured into a mold and the mold/mixture was heated at 2° C. per minute to 80° C.-90° C. and held for 2 h to form the foam and gel the resin.

Once the foam was formed, the material was further heated to 160° C. to 190° C. and held for 2 h. The part was de-molded, placed on a ceramic plate, and inserted into an inert gas furnace, where it was then heated at 1° C. per minute to 1000° C. under nitrogen and held for 2 h to 4 h. It was then left to cool in the furnace. After cooling, the part had a density in a range of from 0.8 g/cc to 1.1 g/cc.

### Example 11

Hydrates were used as a source of water for foam generation, along with mixed carbonates. The materials included mixed carbonate powder (particle size of 45 micrometers or less) from mineralized produce water, citric acid monohydrate, Cat Tx, a peroxide catalyst (e.g., Luperox 531 peroxide catalyst), and methyl-phenyl vinyl siloxane resin containing silicon hydride pendant groups.

First, 200 g of the resin was mixed with 5 Phr of citric acid monohydrate, 1 Phr of Cat Tx, and 1 Phr of Luperox 531 and stirred for 15 min to thoroughly mix. Next, 400 g of mixed carbonate powder (particle size of 45 micrometers or less) was added to a mixer (e.g., Kitchen Aid or other planetary mixer). With the mixer running (e.g., at a setting of “1”) the 200 g of catalyzed resin was added over a 30 second interval. Mixing continued (e.g., at a setting or 2 or 3) for 5 min to 10 min, after which the mixture should be a very flowable material. With a spatula, the mixture was poured into a mold and the mold/mixture was heated at 2° C. per minute to 90° C.-100° C. and held for 2 h to form the foam.

Once the foam was formed, the material was further heated to 150° C. to cure the resin. The part was de-molded, placed on a ceramic plate, and inserted into an inert gas furnace, where it was then heated at 1° C. per minute to 1000° C. under nitrogen and held for 2 h to 4 h. It was then left to cool in the furnace. After cooling, the part had a density in a range of from 1.0 g/cc to 1.3 g/cc.

### Example 12

Hydride pendant group reactions were used to produce hydrogen as the blowing agent. The materials included XM-804 siloxane resin containing silicon hydride pendant groups, water-in-oil surfactant, and DABCO.

First, 100 g of the resin was mixed with 6.2 Phr of surfactant and 6.4 Phr of DABCO in an 800 milliliter (ml) beaker using a mechanical stirrer with a 2 inch Cowels' blade at 800 revolutions per minute (rpm) for 5 min to 10 min to generate the foam. Stirring then continued at 800 rpm for 20 min to 120 min (the time to thicken is a function of the viscosity of the resin, higher viscosity resin takes a shorter time to thicken enough to foam—as would be expected) and the foam was allowed to thicken up until it began to rotate with the stirrer blade.

The very thick mixture was poured into a 6 inch×6 inch×2 inch aluminum or aluminum foil tray, using a spatula to assist in removing the thick mix from the beaker. The foam was allowed to rise/cure for a minimum of 12 h in the tray, and the volume should increase by about a factor of 3× to 4×. After the foam had risen and the surface was no longer sticky, the tray was placed in a convection oven and heated to 90° C. and held for 1 h, followed by heating to 110° C. and held for 2 h, and then heated to 140° C. and held for 2 h. The oven was shut off, and the foam was allowed to cool to below 60° C. before the tray was removed from the oven.

The foam was removed from the tray and placed on a ceramic plate capable of being heated to 1000° C. The foam was then pyrolyzed by heating at 1° C. per minute in flowing nitrogen or argon up to 1000° C. and held at 1000° C. for 2 h. The foam was allowed to cool in the furnace to below 100° C. The resulting ceramic foam will have decreased in volume by 40% to 60% depending on the initial pore size and volume expansion. The density will have increased by 50% to 75% depending on the original density.

The resulting foam had a pore size in a range of from 50 microns to 500 microns, a density in a range of from 0.139 g/cc (8.66 pounds per cubic foot (lb/ft³)) to 0.362 g/cc (22.6 lb/ft³), and a flexure strength in a range of from 100 psi (for the lowest density) to over 1000 psi (for the higher density listed).

### Example 13

Hydride pendant groups and atmospheric moisture reactions were used to produce hydrogen and water vapor as the blowing agent. The materials included XM-804 siloxane resin containing silicon hydride pendant groups, water-in-oil surfactant, DABCO, and dibutyltin dilaurate catalyst.

First, 100 g of the resin was mixed with 6.2 Phr of surfactant and 6.4 Phr of DABCO in an 800 ml beaker using a mechanical stirrer with a 2 inch Cowels' blade at 800 rpm for 5 min to 10 min to generate the initial foam. Then, 4.10 Phr of dibutyltin dilaurate was slowly added drop by drop. Stirring then continued at 800 rpm for 18 min to 90 min (18 min to 22 min for 800 centipoise (cps) resin to 90 min for 240 cps resin) and the foam was allowed to thicken up until it began to rotate with the stirrer blade.

The very thick mixture was poured into a 6 inch×6 inch×2 inch aluminum or aluminum foil tray, using a spatula to assist in removing the thick mix from the beaker. The foam was allowed to rise/cure for a minimum of 6 h in the tray, and the volume should increase by about a factor of 3× to 6×. After the foam had risen and the surface was no longer sticky, the tray was placed in a convection oven and heated to 90° C. and held for 1 h, followed by heating to 110° C. and held for 2 h, and then heated to 140° C. and held for 2 h. The oven was shut off, and the foam was allowed to cool to below 60° C. before the tray was removed from the oven.

The foam was removed from the tray and placed on a ceramic plate capable of being heated to 1000° C. The foam was then pyrolyzed by heating at 1° C. per minute in flowing nitrogen or argon up to 1000° C. and held at 1000° C. for 2 h. The foam was allowed to cool in the furnace to below 100° C. The resulting ceramic foam will have decreased in volume by 40% to 60% depending on the initial pore size and volume expansion. The density will have increased by 50% to 75% depending on the original density.

The resulting foam had a pore size in a range of from 50 microns to 500 microns, a density in a range of from 0.077 g/cc (4.82 lb/ft³) to 0.288 g/cc (18 lb/ft³), and a flexure strength in a range of from 80 psi (for the lowest density) to over 800 psi (for the higher density listed).

It is noted that increasing the amount of surfactant and DABCO, coupled with raising the stirrer speed to 1200 rpm, will increase the expansion of the foam and decrease the density of the cured foam to as low as 0.047 g/cc (2.93 lb/ft³), which results in a density of 0.08 g/cc (4.9 lb/ft³) as pyrolyzed.

### Example 14

Hydride pendant groups and water addition were used to produce hydrogen and water vapor as the blowing agent. The materials included XM-804 siloxane resin containing silicon hydride pendant groups, water-in-oil surfactant, distilled or deionized water, DABCO, and dibutyltin dilaurate catalyst.

First, 100 g of the resin was mixed with 6.2 Phr of surfactant in an 800 ml beaker using a mechanical stirrer with a 2 inch Cowels' blade at 800 rpm for 5 min to 10 min to emulsify the surfactant. Then, 2 Phr of distilled/deionized water was added, and the mixture was mixed at 1200 rpm for an additional 10 min. Then, 6.4 Phr of DABCO was added, and the mixture was mixed at 1200 rpm for an additional 10 min. Then, 4.10 Phr of dibutyltin dilaurate was slowly added drop by drop. Stirring then continued at 800 rpm for 5 min to 20 min depending on the initial viscosity of the resin (about 5 min for 800 cps resin to 20 min for 240 cps resin) and the foam was allowed to thicken up until it began to rotate with the stirrer blade.

The very thick mixture was poured into a 6 inch×6 inch×2 inch aluminum or aluminum foil tray, using a spatula to assist in removing the thick mix from the beaker. The foam was allowed to rise/cure for a minimum of 6 h in the tray, and the volume should increase by about a factor of 3× to 6×. After the foam had risen and the surface was no longer sticky, the tray was placed in a convection oven and heated to 90° C. and held for 1 h, followed by heating to 110° C. and held for 2 h, and then heated to 140° C. and held for 2 h. The oven was shut off, and the foam was allowed to cool to below 60° C. before the tray was removed from the oven.

The foam was removed from the tray and placed on a ceramic plate capable of being heated to 1000° C. The foam was then pyrolyzed by heating at 1° C. per minute in flowing nitrogen or argon up to 1000° C. and held at 1000° C. for 2 h. The foam was allowed to cool in the furnace to below 100° C. The resulting ceramic foam will have decreased in volume by 40% to 60% depending on the initial pore size and volume expansion. The density will have increased by 50% to 75% depending on the original density.

The resulting foam had a pore size in a range of from 50 microns to 200 microns, a density in a range of from 0.210 g/cc (13.3 lb/ft³) to 0.263 g/cc (16.4 lb/ft³), and a flexure strength in a range of from 400 psi (for the lowest density) to over 700 psi (for the higher density listed).

It is noted that changing the amount of water from 2 Phr to 12 Phr will result in the density increasing from 0.210 g/cc (13.3 lb/ft³) to 0.402 g/cc (25.1 lb/ft³), with the flexure strength ranging from 400 psi to over 1100 psi. Adding at least 2 Phr of water also decreases the pore size by about 30% to 50% relative to not adding water.

### Example 15

Hydride pendant groups in a phenyl-methyl-vinyl-hydride siloxane and atmospheric moisture reactions were used to produce hydrogen and water vapor as the blowing agent. The materials included HTR 216 Phenyl methyl-vinyl siloxane resin containing silicon hydride pendant groups, water-in-oil surfactant, DABCO, and dibutyltin dilaurate catalyst.

First, 100 g of the resin was mixed with 5.1 Phr of surfactant and 7.1 Phr of DABCO in an 800 ml beaker using a mechanical stirrer with a 2 inch Cowels' blade at 800 rpm for 5 min to 10 min to generate the initial foam. Then, 3.05 Phr of dibutyltin dilaurate was slowly added drop by drop. Stirring then continued at 800 rpm for 14 min to 30 min and the foam was allowed to thicken up until it began to rotate with the stirrer blade.

The very thick mixture was poured into a 6 inch×6 inch×2 inch aluminum or aluminum foil tray, using a spatula to assist in removing the thick mix from the beaker. The foam was allowed to rise/cure for a minimum of 6 h in the tray, and the volume should increase by about a factor of 3× to 4×. After the foam had risen and the surface was no longer sticky, the tray was placed in a convection oven and heated to 90° C. and held for 1 h, followed by heating to 110° C. and held for 2 h, and then heated to 140° C. and held for 2 h. The oven was shut off, and the foam was allowed to cool to below 60° C. before the tray was removed from the oven.

The foam was removed from the tray and placed on a ceramic plate capable of being heated to 1000° C. The foam was then pyrolyzed by heating at 1° C. per minute in flowing nitrogen or argon up to 1000° C. and held at 1000° C. for 2 h. The foam was allowed to cool in the furnace to below 100° C. The resulting ceramic foam will have decreased in volume by 40% to 60% depending on the initial pore size and volume expansion. The density will have increased by 50% to 75% depending on the original density.

The resulting foam had a pore size in a range of from 50 microns to 500 microns, a density in a range of from 0.423 g/cc (26.4 lb/ft³) to 0.463 g/cc (29.0 lb/ft³), and a flexure strength in a range of from 700 psi (for the lowest density) to over 900 psi (for the higher density listed).

### Example 16

Hydride pendant groups, ZIRCONIUM butoxide, and water addition were used to produce hydrogen and water vapor as the blowing agent. The materials included RM-1737 siloxane resin containing silicon hydride pendant groups, zirconium butoxide (80% solution in butyl alcohol), water-in-oil surfactant, distilled or deionized water, DABCO, and dibutyltin dilaurate catalyst.

First, 62.5 g of the resin was mixed with 37.5 g of zirconium butoxide solution in an 800 ml beaker using a mechanical stirrer with a 2 inch Cowels' blade at 800 rpm for 30 min to react the zirconium butoxy groups with the hydride groups (the material will foam up and eventually settle into a hazy liquid. The mixture was heated to 50° C. on a hotplate while stirring to drive off excess butyl alcohol solvent during the 30 min. The beaker was removed from the hotplate, and 6.25 Phr of the surfactant was added, followed by stirring at 800 rpm for 15 min. Then, 6.4 Phr of DABCO was added, and the mixture was mixed at 1200 rpm for an additional 10 min. Then, 4.10 Phr of dibutyltin dilaurate was slowly added drop by drop. Stirring then continued at 1000 rpm for 30 min. Then, 4.5 Phr of distilled/deionized water was added drop by drop. The stirrer was then decreased to 800 rpm, and the foam was allowed to thicken up until it began to rotate with the stirrer blade, which was about 5 min to about 10 min after the all of the distilled/deionized water was added.

The very thick mixture was poured into a 6 inch×6 inch×2 inch aluminum or aluminum foil tray, using a spatula to assist in removing the thick mix from the beaker. The foam was allowed to rise/cure for a minimum of 12 h in the tray, and the volume should increase by about a factor of 3× to 5×. After the foam had risen and the surface was no longer sticky, the tray was placed in a convection oven and heated to 90° C. and held for 1 h, followed by heating to 110° C. and held for 2 h, and then heated to 140° C. and held for 2 h. The oven was shut off, and the foam was allowed to cool to below 60° C. before the tray was removed from the oven.

The foam was removed from the tray and placed on a ceramic plate capable of being heated to 1000° C. The foam was then pyrolyzed by heating at 1° C. per minute in flowing nitrogen or argon up to 1000° C. and held at 1000° C. for 2 h. The foam was allowed to cool in the furnace to below 100° C. The resulting ceramic foam will have decreased in volume by 40% to 60% depending on the initial pore size and volume expansion. The density will have increased by 50% to 75% depending on the original density.

The resulting foam had a pore size in a range of from 50 microns to 500 microns and a density in a range of from 0.160 g/cc (10.0 lb/ft³) to 0.173 g/cc (10.8 lb/ft³).

It is noted that the addition of zirconium into the SiOC ceramic resulted in a SiOCZr hybrid ceramic with higher temperature capability in both air and inert gas than pure SiOC ceramic.

### Example 17

Hydride pendant groups on a SiC ceramic precursor and distilled water reactions were used to produce hydrogen and water vapor as the blowing agent. The materials included a silicon carbide (Sic) forming polymer (e.g., SMP-10 or SMP-75 SiC forming polymer) containing silicon hydride pendant groups, water-in-oil surfactant, distilled or deionized water, DABCO, and dibutyltin dilaurate catalyst.

First, 100 g of the resin was mixed with 6.2 Phr of surfactant and 6.4 Phr of DABCO in an 800 ml beaker using a mechanical stirrer with a 2 inch Cowels' blade at 800 rpm for 5 min to 10 min to generate the initial foam. Then, 4.10 Phr of dibutyltin dilaurate was slowly added drop by drop. Stirring then continued at 800 rpm for 10 min to 20 min and the foam was allowed to thicken up until it began to rotate with the stirrer blade. The water can optionally be added similarly to how it was added in Example 14 or how it was added in Example 16.

The very thick mixture was poured into a 6 inch×6 inch×2 inch aluminum or aluminum foil tray, using a spatula to assist in removing the thick mix from the beaker. The foam was allowed to rise/cure for a minimum of 6 h in the tray, and the volume should increase by about a factor of 3× to 6×. After the foam had risen and the surface was no longer sticky, the tray was placed in a convection oven and heated to 90° C. and held for 1 h, followed by heating to 110° C. and held for 2 h, and then heated to 140° C. and held for 2 h. The oven was shut off, and the foam was allowed to cool to below 60° C. before the tray was removed from the oven.

The foam was removed from the tray and placed on a ceramic plate capable of being heated to 1000° C. The foam was then pyrolyzed by heating at 1° C. per minute in flowing nitrogen or argon up to 1000° C. and held at 1000° C. for 2 h. The foam was allowed to cool in the furnace to below 100° C. The resulting ceramic foam will have decreased in volume by 40% to 60% depending on the initial pore size and volume expansion. The density will have increased by 50% to 75% depending on the original density.

The resulting foam had a pore size in a range of from 100 microns to 600 microns, a density in a range of from 0.187 g/cc (11.7 lb/ft³) to 0.437 g/cc (27.3 lb/ft³) for SMP-10, a density in a range of from 0.327 g/cc (20.4 lb/ft³) to 0.337 g/cc (21.1 lb/ft³) for SMP-75, and a flexure strength in a range of from 295 psi (for the lowest density) to over 500 psi (for the higher density listed).

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A ceramic foam material, comprising:
a ceramic matrix derived from pyrolysis of an inorganic polymer,
wherein the ceramic foam material is fabricated by mixing the inorganic polymer with at least one filler, optionally a catalyst, optionally a blowing agent, and optionally a foaming agent.

2. The ceramic foam material according to claim 1, wherein the inorganic polymer comprises a siloxane-based polymer or a polycarbosilane-based polymer.

3. The ceramic foam material according to claim 1, wherein the at least one filler comprises at least one of bituminous coal, lignite coal, sub-bituminous coal, anthracite coal, and a carbon powder from a non-coal source.

4. The ceramic foam material according to claim 1, wherein the at least one filler comprises hollow glass microspheres.

5. The ceramic foam material according to claim 1, wherein the catalyst was present in the fabrication of the ceramic foam material, and wherein the catalyst is a platinum complex catalyst, a tin complex catalyst, or 1,4-diazabicyclo[2.2.2]octane (DABCO).

6. The ceramic foam material according to claim 1, wherein the blowing agent was present in the fabrication of the ceramic foam material, and wherein the blowing agent is DABCO.

7. The ceramic foam material according to claim 1, wherein the ceramic foam material comprises porosity generated, during the fabrication of the ceramic foam material, by a reaction of silicon hydride pendant groups present on the inorganic polymer.

8. The ceramic foam material according to claim 1, wherein the ceramic foam material has a pore size in a range of from 50 microns to 600 microns.

9. The ceramic foam material according to claim 1, wherein the inorganic polymer comprises a siloxane-based polymer,
wherein the at least one filler comprises at least one of bituminous coal, lignite coal, sub-bituminous coal, anthracite coal, a carbon powder from a non-coal source, and hollow glass microspheres,
wherein the catalyst was present in the fabrication of the ceramic foam material, and wherein the catalyst is a platinum complex catalyst, a tin complex catalyst, or DABCO, and
wherein the ceramic foam material has a pore size in a range of from 50 microns to 600 microns.

10. A ceramic foam material, comprising:
a ceramic matrix derived from pyrolysis of an inorganic polymer,
wherein the ceramic foam material is fabricated by self-reacting the inorganic polymer to produce in situ blowing agents by using at least one catalyst, and
optionally wherein at least one of a surfactant, water, and alcohol is used in the fabrication of the ceramic foam material to control a pore size of the ceramic foam material.

11. A method of fabricating a ceramic foam material, the method comprising:
forming an intermediate mixture by mixing an inorganic polymer with at least one filler, optionally a catalyst, optionally a blowing agent, and optionally a foaming agent; and
heating the intermediate mixture to cure the intermediate mixture, pyrolyze the inorganic polymer, and form the ceramic foam material.

12. The method according to claim 11, wherein the inorganic polymer comprises a siloxane-based polymer or a polycarbosilane-based polymer.

13. The method according to claim 11, wherein the at least one filler comprises at least one of bituminous coal, lignite coal, sub-bituminous coal, and anthracite coal.

14. The method according to claim 11, wherein the at least one filler comprises a carbon powder from a non-coal source.

15. The method according to claim 11, wherein the at least one filler comprises hollow glass microspheres.

16. The method according to claim 11, wherein the catalyst is present in the intermediate mixture, and wherein the catalyst is a platinum complex catalyst, a tin complex catalyst, or 1,4-diazabicyclo[2.2.2]octane (DABCO).

17. The method according to claim 11, wherein the blowing agent is present in the intermediate mixture, and wherein the blowing agent is DABCO.

18. The method according to claim 11, wherein the ceramic foam material comprises porosity generated, during the fabrication of the ceramic foam material, by a reaction of silicon hydride pendant groups present on the inorganic polymer.

19. The method according to claim 11, wherein the ceramic foam material has a pore size in a range of from 50 microns to 600 microns.

20. The method according to claim 11, wherein the inorganic polymer comprises a siloxane-based polymer,
wherein the at least one filler comprises at least one of bituminous coal, lignite coal, sub-bituminous coal, anthracite coal, a carbon powder from a non-coal source, and hollow glass microspheres,
wherein the catalyst is present in the intermediate mixture, and wherein the catalyst is a platinum complex catalyst, a tin complex catalyst, or DABCO, and
wherein the ceramic foam material has a pore size in a range of from 50 microns to 600 microns.
